(19) United States
(12) Patent Application Publication
(10) Pub. No.: US 2015/0221234 A1
(43) Pub. Date: Aug. 6, 2015

(54) Computerized System and Method for Automated Computer Grading of CAD 2D and 3D Geometry Assignments

(71) Applicant: Pavel Solin, Reno, NV (US)

(72) Inventor: Pavel Solin, Reno, NV (US)

(21) Appl. No.: 14/172,475

(22) Filed: Feb. 4, 2014

(51) Int. Cl. G09B 19/00

(52) U.S. Cl. CPC G09B 19/0053

(57) ABSTRACT

A computerized system, method, and code to automatically assess the correctness of a user's solution to a computer-aided design (CAD) 2D and 3D assignment, comprising: an instructor creating and storing in a memory of testing computer system a probing data set; submitting to the testing computer from user's computer system via a network a user's solution to a CAD assignment; assessing the correctness of the user's solution by the testing computer processor using the probing point set; and, transmitting to, and displaying on the user's computer system whether the solution is correct. If the solution is not correct, then the user may immediately re-compute and re-submit their solution to the testing computer system. Correctness is determined by the testing computer system conducting tests on the user's solution as compared to the instructor's solution, comprising one or more of a size test, position test, inclusion test and complement test.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present invention is generally directed to an online method for a centralized computer system to grade computer-software-generated two- and three-dimensional geometries created by students as part of a 3D modeling/CAD design tutorial, training, or course.

### BACKGROUND OF THE INVENTION

Computer-aided design (CAD) comprises the use of computer programs, or computer code, to create two- or three-dimensional (2D or 3D) graphical representations of physical objects. The benefits of using CAD comprise, for example: lower product development costs, increased productivity, improved product quality and faster time-to-market; better visualization of the final product, sub-assemblies and constituent parts in a CAD system speeds up the design process; greater accuracy, so errors are reduced; and, easier, more robust documentation of the design, including geometries and dimensions, bills of materials, etc.

CAD is utilized in a variety of industries, such as in the entertainment industry for computer animation and special effects in movies, in advertising, in manufacturing to compute an optimum shape and size for a product, etc. Furthermore, CAD is utilized by professional engineers in product and industrial design, to create detailed 3D solid or surface models, or 2D vector-based drawings of physical components. It is also used throughout the engineering process, from the conceptual design and layout of products phase, to the strength and dynamic analysis of assembly's phase, to allow an engineer to both interactively and automatically analyze design variants. Thus the engineer through the use of CAD is able to find the optimal design for manufacturing a product while minimizing the use of physical prototypes.

There are a multitude of CAD software programs that are available either freely or commercially, as well as tutorials (available online and/or installable on a user's computing device) for a user to learn how to use CAD. But, these tutorials lack functionality for a computer system to automatically (without human assistance) evaluate whether or not a user has correctly completed a practice exercise or a graded assignment. Instead, an instructor grades a CAD/3D modeling assignment by visual inspection, which merely comprises a subjective assessment of whether the user's structure matches the correct solution. In the case of a student-instructor environment, the student must wait on the feedback from the instructor, which impedes their learning progress.

Therefore, there is a need within the computer-aided design field for an automated online method of assessing the accuracy of a student's CAD work, particularly for use as part of an online CAD tutorial that does not require a student to wait for a human instructor to evaluate their work. Instead, the student may immediately see where they have made a mistake and correct it.

### SUMMARY OF THE INVENTION

The various embodiments disclosed herein are directed to a computerized system and method for automated computer assessment, or grading, of 2D and 3D geometries created by means of CAD software. As used herein, the term “Computer-aided design (CAD)” refers to any software or computer code where users can build models (virtual prototypes) of 2D and/or 3D real-world objects using techniques of geometrical (solid) modeling. The purpose of the present invention is to design self-paced online 2D and 3D modeling and/or CAD design courses that users can take on their own with practice assignments for the user to test their knowledge. In the various embodiments, the user may be a student and the designer of the tutorial may be an instructor whom the student is not required to wait on to have them evaluate their submitted solutions to assignments. Instead the student receives instantaneous feedback from a computer system, disclosing the correctness of their solution, and potentially where mistakes were made. The student is then able to immediately make the adjustment, and re-submit their solution for re-grading by the computer system.

A key requirement for these online and downloadable courses is automated computer grading of 2D/3D modeling assignments. The present invention makes it possible for a computer system to decide automatically whether or not the student's solution G to a 2D/3D modeling assignment is correct, and even provide hints to the student where he or she went wrong. The method is based on assignment-specific data (spatial coordinates and/or probing point sets) prepared in advance by an instructor when s/he is creating the student assignment. Upon the student electronically submitting their solution G to a testing server (e.g. a remote central server accessed via the Internet or the student's client computing device for downloaded CAD tutorials), the processor will conduct one or several of the following tests: Size test, Position test, Inclusion test and Complement test, to compare the student's solution G to the approved (master) solution S.

The processor will stop the assessment if any of the conducted tests fails, and electronically notify the student. The student may then immediately correct their work and re-submit it for grading.

The present invention utilizes standard functionality of CAD software, comprising: 1) constructing a bounding box B(G) to an object G in 2D or 3D space, and retrieving its coordinates; 2) calculating intersections of objects in 2D or 3D space; 3) subtracting objects from each either in 2D or 3D space; and, 4) determining whether an object is an empty set (such as the intersection of two non-overlapping objects).

The present invention may be implemented into or used in conjunction with any CAD software that provides the above functionality, and/or on any computer platform where underlying CAD software operates. Thus, one embodiment of the present invention comprises a computerized system, method, and non-transitory computer program code comprising a CAD online tutorial with automated computer grading of two and three dimensional modeling assignments for students. Another embodiment may further comprise just the automated computer grading module, which may or may not be incorporated with existing CAD tutorials.

In the various embodiments, the computer system and method of the present invention to assess a 2D and/or 3D solution submitted by a student to an instructor's assignment, first requires that the instructor, or creator of the tutorial, defines probing data, comprising one or more of the following: 1) four coordinates xₘᵢₙ, xₘₐₓ, yₘᵢₙ, yₘₐₓ in 2D, or six coordinates xₘᵢₙ, xₘₐₓ, yₘᵢₙ, yₘₐₓ, zₘᵢₙ, zₘₐₓ in 3D; and, 2) a pair of point sets: Subset S₀ of the approved solution S, and Subset C₀ of the complement C(S). The probing data is then stored in memory on, or otherwise made accessible to, the testing server's processor.

The automated method of the various embodiments for accessing the accuracy or correctness of a student's submitted solution G to a CAD assignment, comprises the following primary steps: a) computing and storing in a testing computer system memory probing data; b) submitting from a user's computing device a user's solution G to a CAD assignment; c) assessing the correctness of the solution G by a processor of the testing computer system; and, d) displaying on the user's computing device whether the solution G is correct. A user's client computing device and a testing computer system may be one and the same (e.g. the CAD program is installed on the user's client computing device and comprises the testing modules of the present invention); and/or the testing computer system comprises a remote server accessible via a network from the user's device.

Various embodiments of the presently disclosed subject matter may include or be embodied in the form of computer-implemented systems, methods or processes and apparatuses for practicing those methods or processes; and, in the form of a computer program product having computer program code containing instructions embodied in non-transitory and/or tangible media. The present invention further comprises computer code comprising non-transitory computer readable medium containing computer executable instructions to carry out, by the processor of system servers, the methods disclosed herein. When the computer program code is loaded into and executed by a computer (e.g. 210-220), the computer becomes an apparatus for practicing embodiments of the disclosed subject matter.

### BRIEF DESCRIPTION OF THE DRAWINGS

The above and other features, aspects, and advantages of the present invention will become better understood with regard to the following description, appended claims, and accompanying drawings where:

FIG. 1 is an illustration of an approved (master) Solution S to a model Assignment A1.

FIG. 2 is an illustration of a Bounding box B(S)=(0, 5)×(0, 4) to the solution S from FIG. 1.

FIG. 3 is an illustration of Complement C(S) of the point set S from FIG. 1, truncated to the size of the bounding box B(S). In other words, shown is the intersection of C(S) with B(S).

FIG. 4 is an illustration of Subset S₀ of the point set S from FIG. 1 (important special case S₀=S).

FIG. 5 is an illustration of Subset S₀ of the point set S from FIG. 1, that is “smaller” than S.

FIG. 6 is an illustration of Subset C₀ of the complement C(S) from FIG. 3 (important special case where C₀ is C(S) truncated to the size of B(S)). In other words, C₀ is equal to the intersection of C(S) and B(S).

FIG. 7 is an illustration of Subset C₀ of the complement C(S) from FIG. 3, which is “smaller” than C(S) truncated to the size of B(S).

FIG. 8 is an illustration of Subset S₀ of the solution S from FIG. 1, containing a finite number of discrete points.

FIG. 9 is an illustration of Subset C₀ of the complement C(S) from FIG. 3, containing a finite number of discrete points.

FIG. 10 is a flowchart of computer steps of the present invention for the method of testing a student's solution for size, position, inclusion, and complement.

FIG. 11 is an illustration of a Student's solution G to Assignment A1 for the Size Test.

FIG. 12 is an illustration of Student's solution G failing the Size Test with Bounding box B(G) for Student's solution G from FIG. 11.

FIG. 13 is an illustration of a Student's solution G to Assignment A1 for the Inclusion Test.

FIG. 14 is an illustration demonstrating solution G failing the Inclusion Test with a Greyed-out area comprising the set X(S₀, G).

FIG. 15 is an illustration of a Student's solution G to Assignment A1 for the Complement Test.

FIG. 16 is an illustration that the Size Test passes for solution G from FIG. 15.

FIG. 17 is an illustration that the Inclusion Test passes since S₀ lies entirely in G, and thus X(S₀, G) is an empty set.

FIG. 18 is an illustration that the Complement Test fails due to the non-empty greyed-out area which is the intersection I(C₀, G) of the probing set C₀ with the set G.

FIGS. 19-27 are illustrations demonstrating a 3D Student's solution G undergoing the Size, Position, Inclusion, and Complement Test for model Assignment A2.

FIG. 19 is an illustration of the model Assignment A2: a 4″×4″ rubber gasket with round corners and four holes (top view).

FIG. 20 is an illustration of approved (master) Solution S to Assignment A2.

FIG. 21 is an illustration of Bounding box B(S) of the solution S.

FIG. 22 is an illustration of Subset S₀ of the solution S (we have chosen to use S₀=S).

FIG. 23 is an illustration of Subset C₀ of the complement C(S) (we have chosen to use C₀ being the intersection of C(S) and B(S)).

FIG. 24 is an illustration of an incorrect Student's solution G to Assignment A2 where larger radius 0.6″ is used for the holes.

FIG. 25 is an illustration of a non-empty set X(S₀, G) calculated in the Inclusion Test.

FIG. 26 is an illustration of an incorrect student's solution G to Assignment A2 where smaller radius 0.5″ is used for the round corners.

FIG. 27 is an illustration of a non-empty point set I(C₀, G) calculated in the Complement Test.

FIG. 28 is an illustration of a simpler probing set S₀, that will be used for the Inclusion Test (the greyed-out area shows the top view).

FIG. 29 is an illustration of the 3D view of the probing point set S₀ from FIG. 28.

FIG. 30 is an illustration of the probing point set C₀ that will be used for the Complement Test (the greyed-out area showing the top view).

FIG. 31 is an illustration of the 3D view of the probing point set C₀ from FIG. 30.

FIG. 32 is an illustration of the result of the Inclusion Test—the set X(S₀, G).

FIG. 33 is an illustration of the result of the Complement Test—the intersection I(C₀, G) of the probing set C₀ and the student's geometry G.

FIG. 34 is a block diagram of one embodiment of the system architecture comprising an online tutorial as viewed on a student's electronic computing device in communication with a central system server storing the computer code of the present invention.

FIG. 35 is a block diagram of one embodiment of the user's (student's and instructor's) electronic computing device, which may have CAD software installed thereon, or accessible via the network.

### DETAILED DESCRIPTION

### Glossary of Terms

As used herein, the term “module” refers to a portion of a computer program or software that carries out a specific function and may be used alone or combined with other modules of the same program.

As used herein, the term “assignment” refers to an accurate verbal and/or graphical description of a 2D or 3D geometry to be created by a student or trainee. S/he may be utilizing an underlying CAD software to complete the assignment.

The following illustrates an exemplification of a two dimensional (2D) and three dimensional (3D) model assignment, respectively:

Assignment A1: Create a 2D object that is a polygon in the xy-plane spanning vertices (0, 0), (5, 0), (5, 2), (2.5, 4) and (0, 2), from which the square (1, 2)×(1, 2) and the rectangle (3, 4)×(0, 2) are removed.

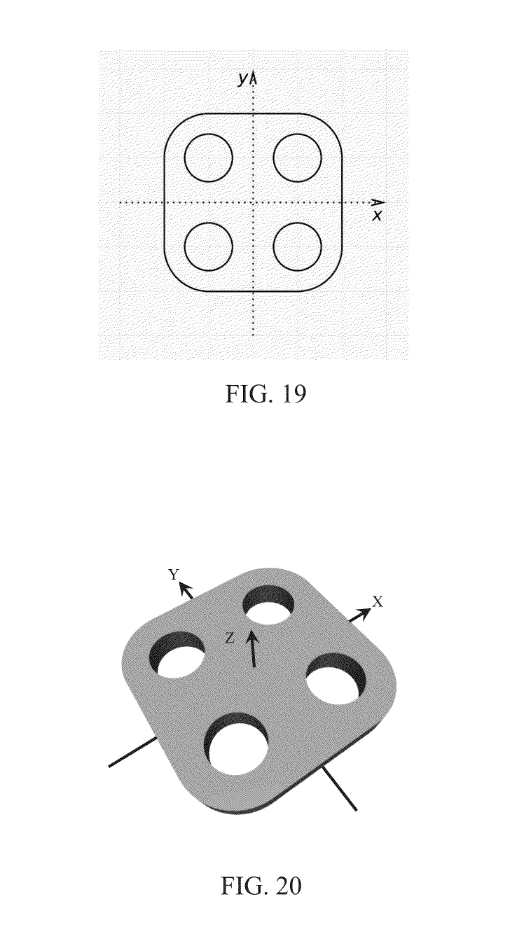

Assignment A2: Create a 3D model of a 4″×4″ rubber gasket with round corners and four holes whose top view is shown in FIG. 19. The thickness of the gasket is 0.5″, outer radii at the corners 1″, and radii of the holes 0.5″. The centers of the holes have coordinates (1, 1), (−1, 1), (−1, −1) and (1, −1).

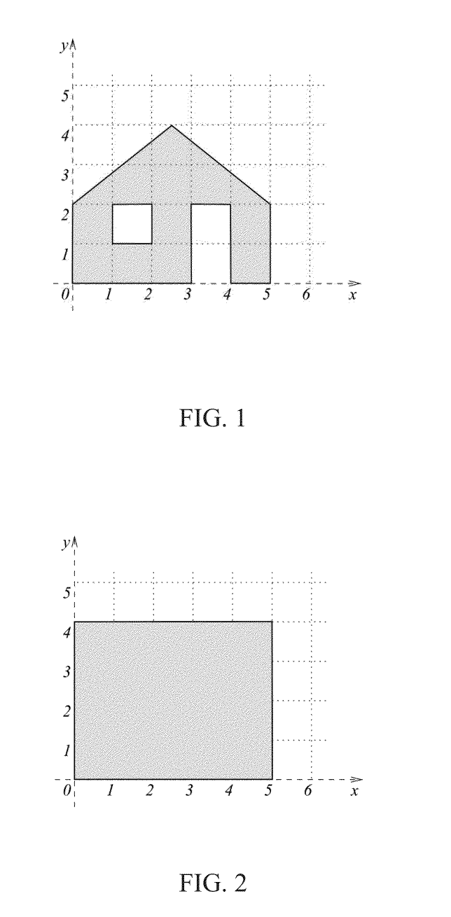

As used herein, the terms “solution”, “design”, or “geometry” refer to a 2D or 3D point set that fulfills the requirements defined in the assignment as determined by the instructor or designer of the assignment. FIG. 1 shows a 2D point set “S” that is the instructor's (approved, master) solution to Assignment A1. A student's submitted solution is herein referred to as “G”.

As used herein, the term “bounding box B(S)” of a point set S refers to a 2D or 3D point set B(S) representing the smallest (minimum) rectangle (in 2D) or brick (in 3D) that contains the set S, and whose edges are parallel to the coordinate axes. In 2D, a bounding box is the Cartesian product of two one-dimensional intervals (xₘᵢₙ, xₘₐₓ)×(yₘᵢₙ, yₘₐₓ). In 3D, a bounding box is the Cartesian product of three intervals (xₘᵢₙ, xₘₐₓ)×(yₘᵢₙ, yₘₐₓ)×(zₘᵢₙ, zₘₐₓ). These four (in 2D) or six (in 3D) coordinates uniquely determine the bounding box. For illustration, FIG. 2 shows the 2D bounding box B(S) to the point set S from FIG. 1.

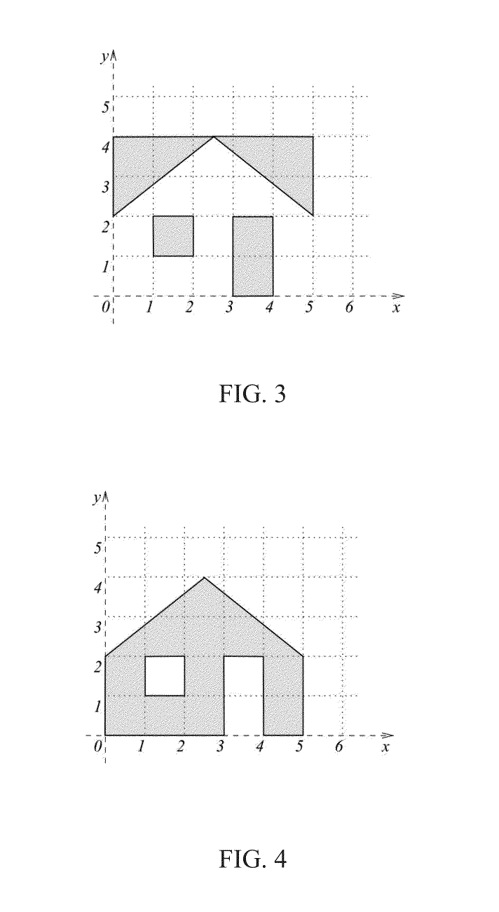

As used herein, the term “complement C(S)” of a point set S refers to a point set representing the entire exterior space to the set S. Mathematically, C(S) is the result of subtracting the set S from the entire 2D space (2D assignments) or from the entire 3D space (3D assignments). Since the 2D or 3D objects in CAD design always have finite size, the complement C(S) always is unbounded (infinitely large, extending from negative infinity to infinity in all spatial directions). Therefore, we will always work with its truncated subsets (bounded subsets of finite size). For illustration, FIG. 3 shows the complement C(S) to the point set S from FIG. 1, truncated to the size of the bounding box B(S). In other words, shown is the intersection of C(S) with B(S). The set C(S) itself cannot be shown because it is infinitely large.

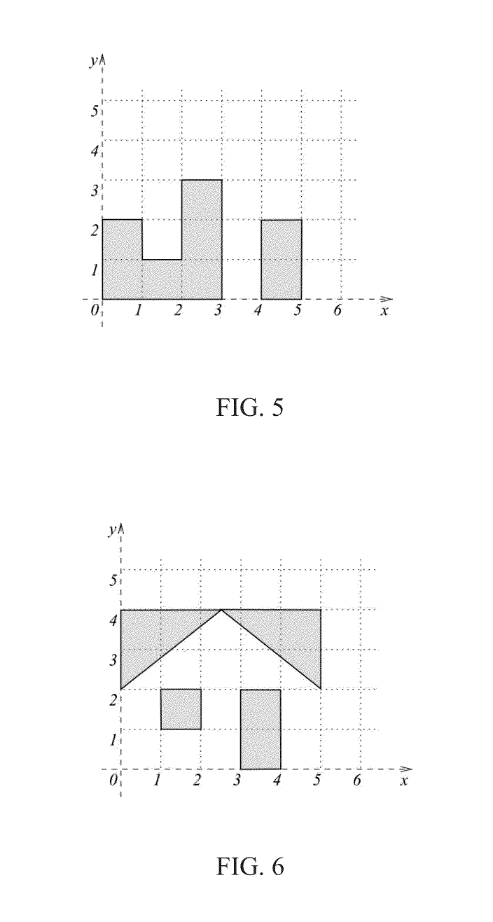

As used herein, we say that S₀ is “subset of S” if all points that belong to S₀ also belong to S. Important case of a subset S₀ of S is the set S itself, i.e., S₀=S, as shown in FIG. 4. Subset S₀ of a set S can also be “smaller” than S(=not equal to S). For illustration, FIG. 5 shows a subset S₀ of the set S from FIG. 1, that is “smaller” than S.

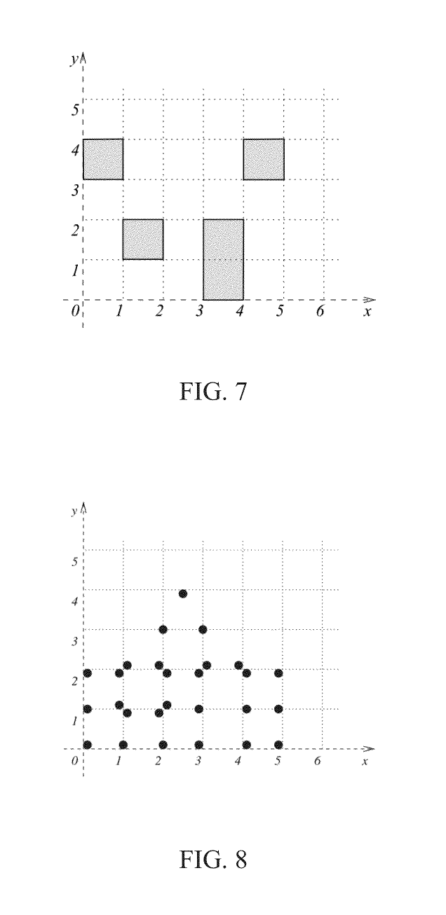

As used herein, we say that C₀ is “subset of C(S)” if all points of C₀ also belong to C(S). FIG. 6 illustrates Subset C₀ of the complement C(S) from FIG. 3 (important special case where C₀ equals to the intersection of C(S) with B(S)), and FIG. 7 illustrates Subset C₀ of the complement C(S) from FIG. 3, that is “smaller” than the intersection of C(S) with B(S).

As used herein, the term “probing data” refers to an instructor's selected data set comprising one or more of the following: Coordinates for the bounding box B(S) of the approved (master) solution S, subset S₀ of S, and/or a subset C₀ of C(S).

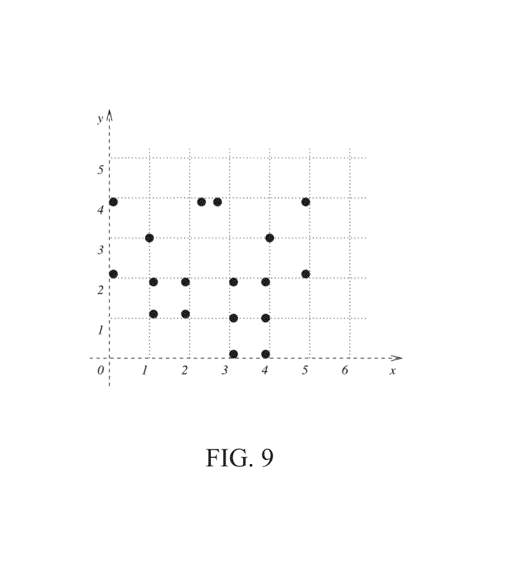

Each of the subsets shown in FIGS. 4-7 contain infinitely many points. However, subsets also can be finite (i.e. they contain a finite number of discrete points). Sample finite subsets of the solution S from FIG. 1 and of the complement C(S) from FIG. 3 are shown in FIGS. 8 and 9, respectively. Here, each black dot represents a unique 2D point located at its center. All points shown in FIG. 8 lie inside the solution S from FIG. 1, and all points shown in FIG. 9 lie inside the complement C(S) from FIG. 3.

### Instructor Selects Probing Data

The instructor or creator of the assignment must select probing data to assess a student's or a user's submitted solution G to the assignment. This data comprises one or more of the following: Coordinates for the bounding box B(S) of the approved (master) solution S, subset S₀ of S, and a subset C₀ of the complement C(S). The probing data is loaded into the testing server and made accessible to the underlying CAD program that is installed on the testing server.

The instructor who (obviously) knows the approved solution S also knows the bounding box B(S). The bounding box B(S) is defined via four coordinates xₘᵢₙ, xₘₐₓ, yₘᵢₙ, yₘₐₓ in 2D, or six coordinates xₘᵢₙ, xₘₐₓ, yₘᵢₙ, yₘₐₓ, zₘᵢₙ, zₘₐₓ in 3D. It is practical to include these coordinates into the probing set and to use them to conduct the Size and/or Position test, because this is an inexpensive and quick way to detect if the student's solution G is obviously wrong. However, there is no strict requirement for using these coordinates: If they are not part of the probing data, then the Inclusion and/or Complement tests can be still used to assess the correctness of the student's solution G.

Furthermore, the instructor prepares 1) Subset S₀ of the approved solution S, as illustrated in FIGS. 4, 5, and 8; and/or 2) Subset C₀ of the complement C(S), as illustrated in FIGS. 6, 7, and 9. The probing data is formed by one or more of the following: Four coordinates xₘᵢₙ, xₘₐₓ, yₘᵢₙ, yₘₐₓ in 2D, or six coordinates xₘᵢₙ, xₘₐₓ, yₘᵢₙ, yₘₐₓ, zₘᵢₙ, zₘₐₓ in 3D; the set S₀, and/or the set C₀.

If the sets S₀ and C₀ are used, then either one can be further decomposed into two or more geometrically simpler subsets in order to optimize computational cost of the tests. See the descriptions of the Inclusion and Complement Tests. For the simplification of the present disclosure, only one set S₀ and one set C₀ are used.

For the simplification of the present disclosure, it is assumed that the instructor includes the coordinates of the bounding box B(S), as well as both sets S₀ and C₀ into the probing data. Leaving out any of this data and skipping some of the subsequently described Size, Position, Inclusion and Complement tests, and/or rearranging their order, comprises various embodiments of the present disclosure. Therefore, the four tests (Size, Position, Inclusion and Complement) disclosed herein are for the sake of completeness with the understanding that any one of them can be left out (and/or the order rearranged) at the instructor's discretion.

Test Fidelity vs. Computational Cost

The selection of probing data determines test fidelity, which is the ability of the test to discover flaws in the student's solution G. There are multiple ways to achieve the highest, 100% fidelity. If the Size and Position tests are used, then 100% fidelity is achieved when the subset S₀ is identical to S, and C₀ contains the intersection of C(S) with B(S). If S₀ is smaller than S or C₀ is smaller than the intersection of C(S) with B(S)) then the test will not be 100% reliable. When one of the Inclusion or Complement tests is not conducted, then the test will not be 100% reliable. If the Size and Position tests are not used, the sets S, and C₀ can still be chosen so that the test is 100% reliable. Ultimately it is up to the instructor to decide whether s/he wants the test to be 100% reliable or if s/he prefers to use a simplified version of the test which typically is faster.

If the test is not 100% reliable, then some flaws in the student's design may go unnoticed. However, especially with complex 3D designs, it often makes sense to sacrifice some test fidelity. This can be done, for example, by using carefully selected, simpler point sets S₀ and C₀, such as rectangles or bricks inserted into the solution S and complement C(S), respectively.

For example, using the bounding box B(S)=(0, 5)×(0.4) from FIG. 2 together with the subsets S₀ and C₀ from FIG. 4 and FIG. 5 yields a 100% reliable test for Assignment A1. The test becomes computationally faster but less reliable with the subsets S₀ and C₀ from FIG. 5 and FIG. 7. The test becomes even faster but even less reliable with the subsets S₀ and C₀ from FIGS. 8 and 9.

In general, the computational cost of the test is proportional to its fidelity. With complex 3D models, it is practical to use subsets S₀ and C₀ that have simpler shapes than the original sets S and C(S), respectively.

### Computer Assignment Assessment Method

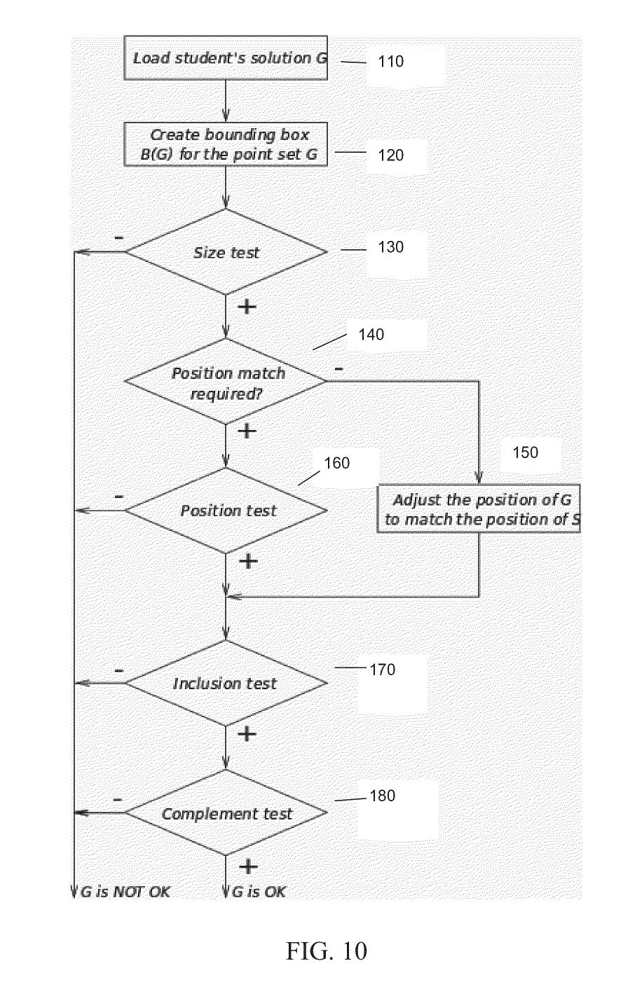

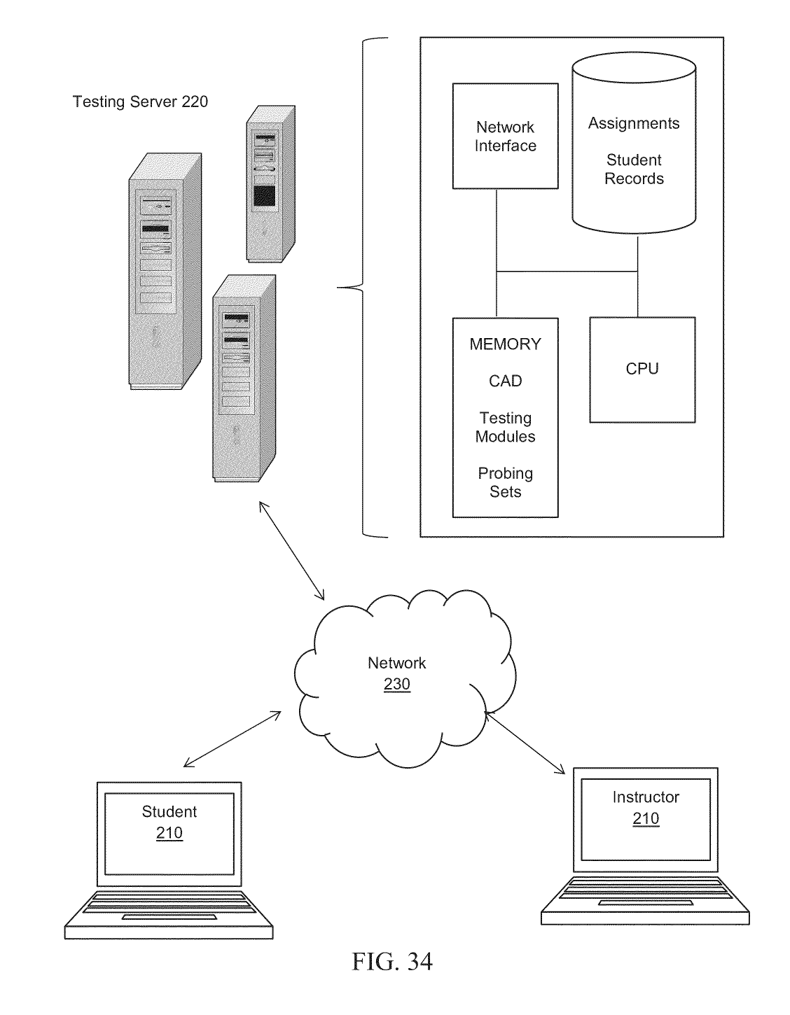

FIG. 10 discloses a flow chart of the computer method for automatically and immediately grading a student's CAD assignment. As stated above, we are going to consider the fullest variant of the testing procedure. Hence, we assume that the instructor has previously prepared the following probing data: Four coordinates xₘᵢₙ, xₘₐₓ, yₘᵢₙ, yₘₐₓ in 2D, or six coordinates xₘᵢₙ, xₘₐₓ, yₘᵢₙ, yₘₐₓ, zₘᵢₙ, zₘₐₓ in 3D; the set S₀, and the set C₀. This data has been uploaded to the testing server where the underlying CAD software is installed (e.g. central system server, FIG. 34, 220). As stated above, the point sets S₀ and C₀ may consist of two or more geometrically simpler parts whose purpose is to optimize the computational cost of the test.

When creating the test, the instructor decides if he/she wants to enforce absolute position of the object, or if a student's solution that differs from the true instructor's solution just by a translation in the 2D or 3D space will be accepted.

In FIG. 10, step 110, the student uploads their solution to the assignment to the testing server 220 (which may not be the same computer that the student used to prepare their solution); alternatively, the student computes their solution on the testing server 220 via the network (see FIG. 34, 230). The uploaded files can have different formats. The format is not important as long as it uniquely determines the bounding box B(S), and the 2D or 3D point sets S₀ and C₀. For example, this can be a script that the underlying CAD software can use to construct the point sets, or the point sets can be provided as STL files. The student's solution will be called G as before.

If the Size and/or Position tests are used, then in step 120, the processor on the central testing server 220 will calculate the bounding box B(G) for the student's geometry G.

### Size Test

In step 130, the underlying CAD software on the testing server, conducts a Size Test to check if the dimensions of the bounding box B(G) of the student's geometry G match the dimensions of the bounding box B(S) of the approved solution S. If so, then the processor continues to step 140; but, if not, then the testing server may transmit and electronic message to the student's client computer stating that G has failed the Size Test.

### Position Test

In step 140, the processor of the central testing server determines whether a Position Test is required. It is only performed (in step 160) if the instructor chooses to require an absolute position in the assignment. For example, the model Assignment A1 does require the 2D object to lie in the rectangle (0, 5)×(0, 4) in the xy-plane. This means that absolute position match is required. In other assignments, however, an absolute position match may not be required—such as in “Create a 2×2 square in the xy-plane whose edges are parallel to the coordinate axes.”. In this case, the square (0, 2)×(0, 2) is an equally correct solution as the square (−1, 1)×(−1, 1) or any other 2×2 square that only differs from these two by a translation in the xy-plane.

If a Position Test is not conducted because there is not a requirement for absolute position in the assignment solution, then the processor skips to step 150—Adjusting position of G computation. In this step the processor translates (moves) the student's geometry G in the 2D/3D space so that the absolute position of the bounding box B(G) of the translated geometry G matches the bounding box B(S). This operation comes after the Size Test, so at this point it is known that the dimensions of the bounding box B(S) of the true solution S and the bounding box B(G) of the student's solution G are the same. Also, the absolute positions of the bounding boxes are known, from where it is easy to calculate the corresponding translation vector.

If the Position Test is required and the student's solution G passes it, or after the processor translates the student's solution G so that the absolute positions of the bounding boxes B(G) to B(S) are the same, then the processor continues on to the Inclusion Test. But when the Position Test is required and the student's solution G fails it, then the student may be notified electronically that their solution has failed the Position Test.

### Inclusion Test

In step 170, the processor conducts an Inclusion Test on the student's geometry G. The purpose of this test is to check whether or not the point set S₀, that (obviously) is a subset of the approved solution S, also is a subset of the student's geometry G. The processor of the testing server 220 conducts the following steps to compute this: 1) Calculate the intersection I(S₀, G) of the point sets S₀ and G. Clearly, if the student's solution is correct, then I(S₀, G) must be identical to S₀; 2) Subtract I(S₀, G) from S₀ and denote the result by X(S₀, G). Clearly, if the student's solution G is correct, then X(S₀, G) must be an empty set; and, 3) If X(S₀, G) is an empty set, then return True, else return False.

In order to optimize computational cost of the Inclusion Test, the set S₀ may be decomposed into geometrically simpler, possibly overlapping subsets S₀₁, S₀₂, . . . (whose set union is the entire set S₀). Then the above steps 1-2 can be performed with each of them separately. The test only passes if all the resulting sets X(S₀₁, G), X(S₀₂, G) etc. are empty sets. In other words, if any of the sets X(S₀₁, G), X(S₀₂, G) etc. is not an empty set, then the test can be finished immediately, returning False.

Additional clarification to optimizing computational cost of the Inclusion Test: If the set S₀ lies entirely in G, then (obviously) the intersection I(S₀, G) is the set S₀ itself. Then subtracting I(S₀, G)=S₀ from S₀ (obviously) yields an empty set X(S₀, G). On the other hand, if part of the set S₀ lies outside of G, then the intersection I(S₀, G) is smaller than S₀, and thus subtracting I(S₀, G) from S₀ yields a non-empty set X(S₀, G).

### Complement Test

In step 180, the central server processor conducts a Complement Test on the student's design G. The purpose of this test is to check whether or not the student's geometry G overlaps with the subset C₀ of the complement C(S). In other words, the Complement test checks whether the student's solution G reaches beyond the boundary of the set S, into the exterior space of the set S. This can be done simply by calculating the intersection I(C₀, G) of the sets C₀ and G. If the set I(C₀, G) is an empty set, then return True. Else return False.

The set C₀ may be decomposed into geometrically simpler, possibly overlapping subsets C₀₁, C₀₂, . . . (whose set union is the entire set C₀) in order to optimize computational cost. Then the Complement Test passes only if all the intersections I(C₀₁, G), I(C₀₂, G) etc. are empty sets. If one of the sets I(C₀₁, G), I(C₀₂, G) etc. is found non-empty, the test can be finished immediately, returning False.

Additional clarification: While the Inclusion Test makes sure that the student's geometry G is not “smaller” than the approved solution S, the Complement Test makes sure that the student's geometry G is not “larger” than the approved solution S.

### Test Results and Feedback

If all the tests (i.e. Size, Position (if enforced), Inclusion, and Complement) pass, then the student's geometry G is marked as correct, else it is marked as incorrect. The result of a failed test can be returned to the student as follows.
1. If Size Test fails, notify the student that his/her geometry G has different outer dimensions than the correct solution S. Show to the student the dimensions of the bounding boxes B(S) and B(G) for comparison.
2. If Position Test is enforced and fails, inform the student that his/her solution has the correct outer dimensions but its absolute position in plane or space is wrong. Show to the student the coordinates of the bounding box B(S) of the correct solution S and the coordinates of the bounding box B(G) that corresponds to his/her geometry G.
3. If Inclusion Test fails, let the student know that his/her geometry G differs from the true solution S, and show to the student the non-empty set X(S₀, G) which was the reason why the Inclusion Test failed.
4. If Complement Test fails, let the student know that his/her geometry G differs from the true solution S, and show to the student the non-empty set I(C₀, G) which was the reason why the Complement Test failed.

### Exemplifications of Two-Dimensional Assignments

In the following exemplifications, it is assumed that the student solves Assignment A1, and that the probing data prepared by the instructor comprise the coordinates of the bounding box B(S) of the approved solution S shown in FIG. 2, approved solution subset S₀ shown in FIG. 4, and approved solution complement subset C₀ from FIG. 6.

### 2D Assignment

Assignment A1: Create a 2D object that is a polygon in the xy-plane spanning vertices (0, 0), (5, 0), (5, 2), (2.5, 4) and (0, 2), from which the square (1, 2)×(1, 2) and the rectangle (3, 4)×(0, 2) are removed.

### Failing the Size Test

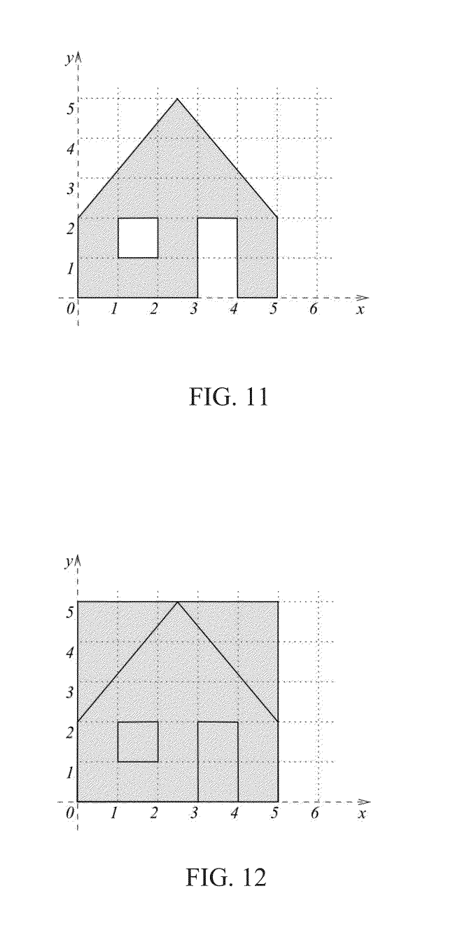

Assume that the student submits the geometry G shown in FIG. 11 as a solution to Assignment A1. Here, the bounding box B(G) has dimensions 5×5 (see FIG. 12) while the bounding box B(S) of the approved solution has dimensions 5×4. Therefore the Size Test fails and the student's solution G is not accepted.

### Failing the Inclusion Test

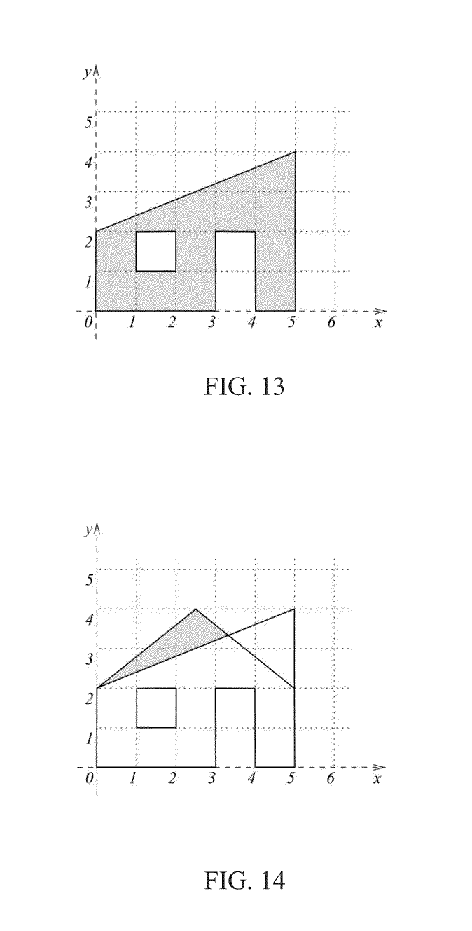

Assume that the student submits the geometry G shown in FIG. 13 as a solution to Assignment A1. This time the Size Test passes since the bounding box B(G) has the correct dimensions 5×4.

And, the Position Test, if enforced, passes since the bounding boxes B(S) and B(G) are the same (0, 5)×(0, 4). However, the Inclusion Test reveals that the probing subset S₀ is not a subset of the set G. The set X(S₀, G), which is the difference of the sets S₀ and I(S₀, G), is shown in FIG. 14. Since the set X(S₀, G) is not empty, the Inclusion Test fails. The set X(S₀, G) can be passed to the student as a hint.

### Failing the Complement Test

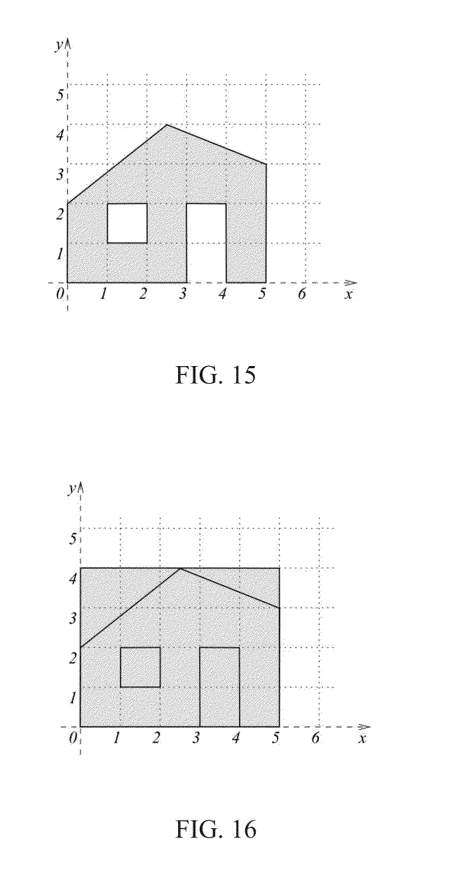

Assume that the student submits the geometry G shown in FIG. 15 as a solution to Assignment A1. As illustrated in FIG. 16, the Size Test passes since the bounding box B(G) for the set G from FIG. 15 has the correct dimensions 5×4.

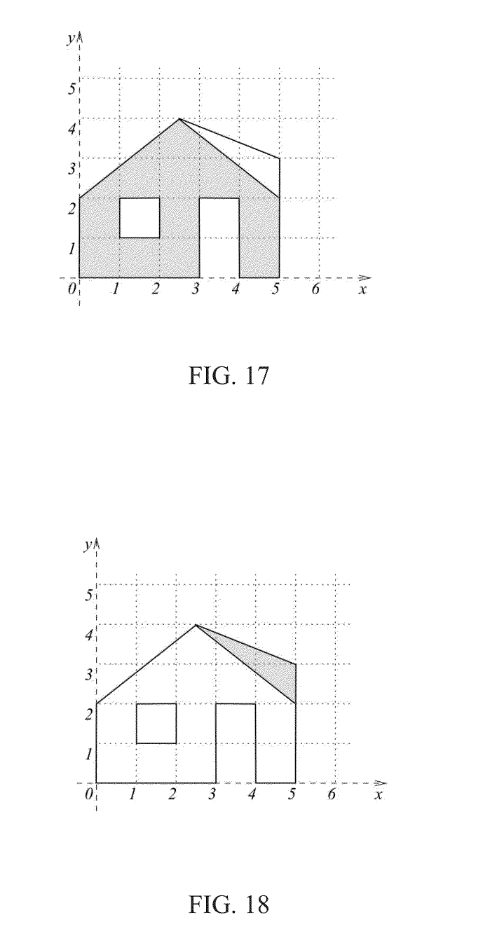

The Position Test, if enforced, passes too since the bounding boxes B(S) and B(G) are the same (0, 5)×(0, 4). Also the Inclusion Test passes since the probing set S₀ is a subset of the set G. This is shown in FIG. 17 where S₀ lies entirely in G, and thus X(S₀, G) is an empty set.

However, the Complement Test fails since the set G has a non-empty intersection with the probing set C₀, as shown in FIG. 18. The greyed-out area is the intersection I(C₀, G) of the probing set C₀ with the set G. The Complement Test fails since the set I(C₀, G) is not empty. In one embodiment, the set I(C₀, G) can be passed to the student as a hint where his/her design is wrong.

### Exemplifications of Three-Dimensional Assignments

The assessment method works in the same way for 2D and 3D designs, as demonstrated with the testing steps in the computer flowchart of FIG. 10 being performed on the student solution G submitted for the following assignment A2:

### 3D Assignment

Assignment A2: Create a 3D model of a 4″×4″ rubber gasket with round corners and four holes whose top view is shown in FIG. 19. The thickness of the gasket is 0.5″, outer radii at the corners 1″, and radii of the holes 0.5″. The centers of the holes have coordinates (1, 1), (−1, 1), (−1, −1) and (1, −1).

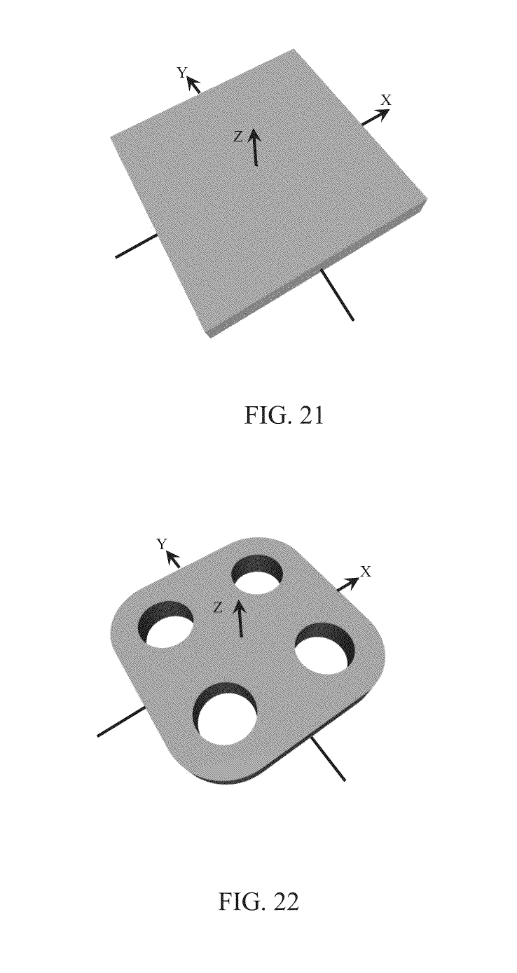

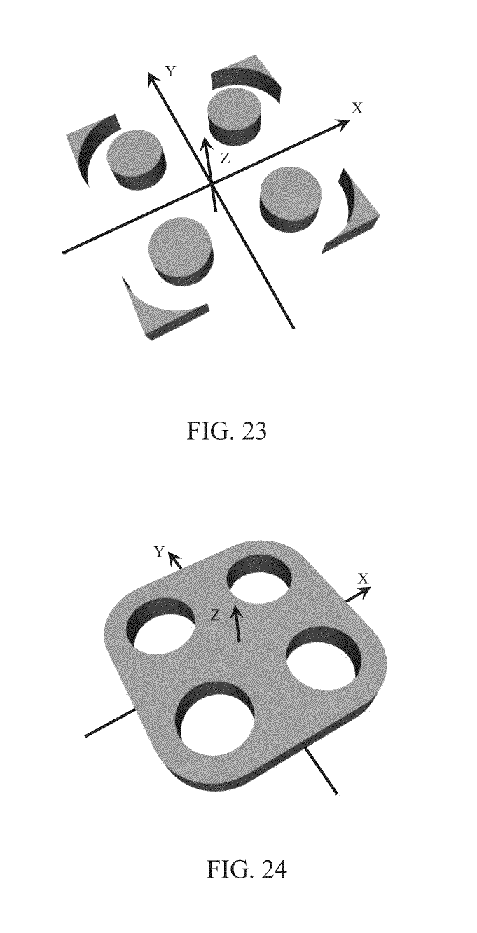

FIG. 19 illustrates a 4″×4″ rubber gasket with round corners and four holes (top view). FIG. 20 illustrates the solution S to Assignment A2. The bounding box B(S) of the solution S has the dimensions (xₘᵢₙ, xₘₐₓ)×(yₘᵢₙ, y^{max})×(zₘᵢₙ, zₘₐₓ)=(−2″, 2″)×(−2″, 2″)×(0, 0.5″) as shown in FIG. 21. For the Inclusion Test, the subset S₀=S is selected, as shown in FIG. 22. For the Complement Test, the subset C₀ defined as the intersection of C(S) and B(S) is selected, as shown in FIG. 23.

In the following, we will not consider simple failures such as a wrong size of the bounding box, because these are trivial to detect. Instead, we will consider failures of the Inclusion and Complement Tests.

### Failing the Inclusion Test

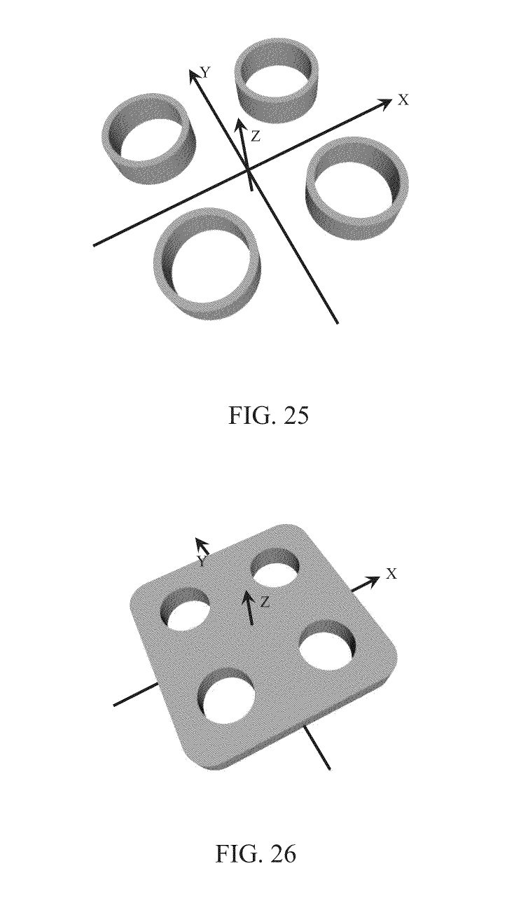

Assume that the student by mistake uses a larger radius 0.6″ for the four holes (correct radius is 0.5″). The student's geometry G is shown in FIG. 24. The set X(S₀, G) calculated in the Inclusion Test is shown in FIG. 25. Since the set X(S₀, G) calculated in the Inclusion Test is non-empty, the Inclusion Test fails and the student's design G is marked as incorrect. The set X(S₀, G) can be passed to the student as a hint where his/her design went wrong.

### Failing the Complement Test

In this example we assume that the student uses an incorrect radius 0.5″ for the round corners (correct radius being 1″). His/her geometry G is shown in FIG. 26. In this case the Inclusion Test passes since the probing subset S₀=S is a subset of G, and thus the set X(S₀, G) is empty.

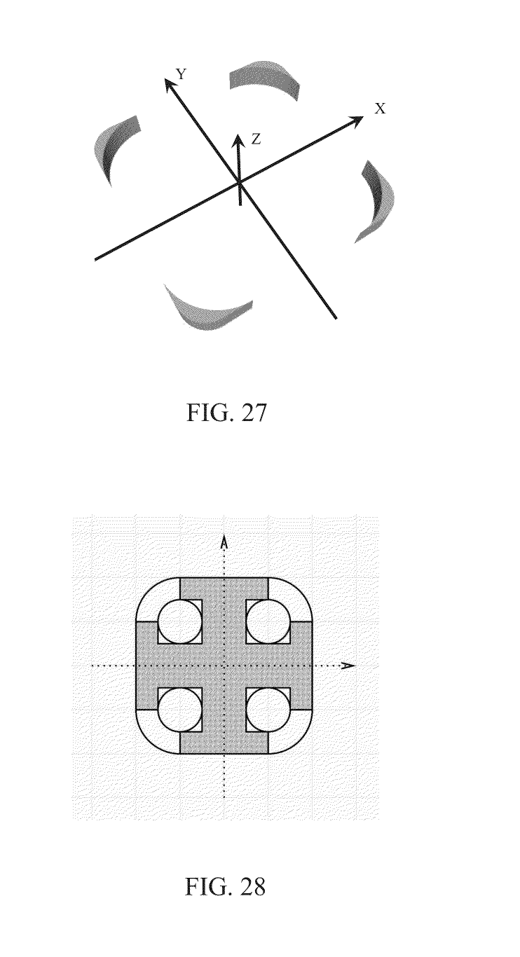

The intersection I(C₀, G) of the probing point set C₀ with the students geometry G is shown in FIG. 27. Since the set I(C₀, G) is non-empty, the Complement Test fails. The set I(C₀, G) can be passed to the student as a hint where his/her design went wrong.

### Exemplification of Imperfect Testing—3D

Assignment A2 is further utilized to illustrate that it is possible to use very simple probing point sets while maintaining high test fidelity. Recall the approved solution S from FIGS. 19 and 20.

### Bounding Box and Probing Point Sets

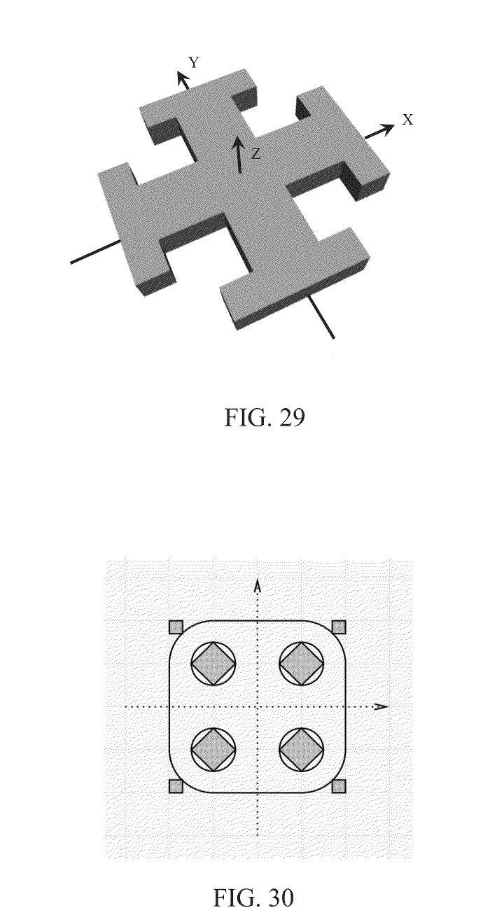

The bounding box B(S) of the solution S remains the same because S has not changed—it has the dimensions (xₘᵢₙ, xₘₐₓ)×(yₘᵢₙ, yₘₐₓ)×(zₘᵢₙ, zₘₐₓ)=(−2″, 2″)×(−2″, 2″)×(0, 0.5″) as shown in FIG. 21. However, this time the Inclusion Test will be done using a different subset S₀ of the approved solution S, which is shown in FIGS. 28 and 29. In FIG. 28 the greyed-out area shows the top view of the simpler probing point set S₀, that will be used for the Inclusion Test. And FIG. 29 is a 3D view of the probing point set S₀ from FIG. 28. The probing point set S₀ shown in FIG. 29 only has 30 faces and no curvilinear faces. This results in lower computational cost compared to the probing point set S₀ from FIG. 22.

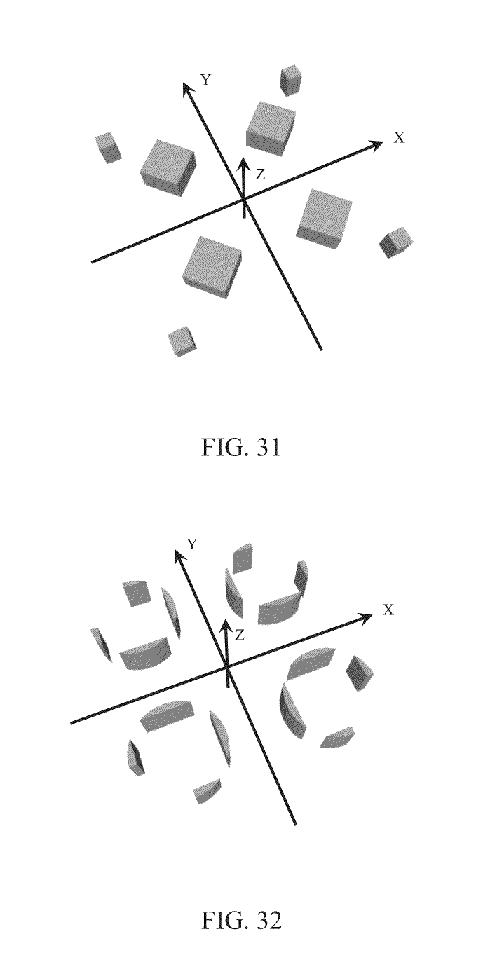

A different probing set C₀ for the Complement Test is selected, as shown in FIGS. 30 and 31. (Recall that this can be any subset of the complement C(S).) FIG. 30's greyed-out area shows the top view of the probing point set C₀ that will be used for the Complement Test. And FIG. 31 is a 3D view of the probing point set C₀ from FIG. 30. Typically, the geometry of the simplified probing sets is easy to calculate. For illustration, the dimensions of the larger bricks in FIG. 31 are 1/sqrt(2)″×1/sqrt(2)″×0.5″ and the dimensions of the smaller bricks in the corners are (1−1/sqrt(2))″×(1−1/sqrt(2))″×0.5″.

### Failing the Inclusion Test

Let's return to FIG. 24 that comprises a student's solution G with a larger radius 0.6″ for the four holes. This solution failed the Inclusion Test with the probing point set S₀ from FIG. 24. This solution G also fails the Inclusion Test with the simplified probing point set S₀ from FIG. 29.

FIG. 32 shows the set X(S₀, G) which is the result of the Inclusion Test. Since the set X(S₀, G) is not empty, the student's solution G fails the Inclusion Test. The set X(S₀, G) can be passed to the student as a possible hint where his/her design went wrong.

### Failing the Complement Test

Let's return to FIG. 26 that illustrates a wrong solution G where the student used an incorrect radius 0.5″ for the round corners (the correct radius being 1″). This geometry passes the first Inclusion Test and it also passed the Inclusion Test with the simplified probing point set S₀, because in both cases the probing point set S₀ is a subset of the geometry G.

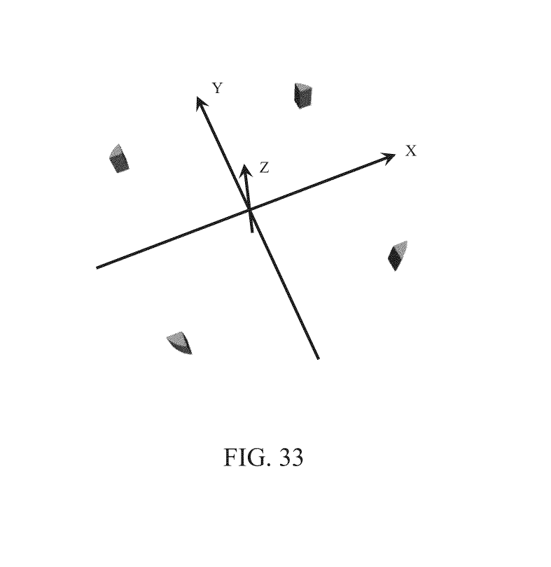

This time the Complement Test is performed using the probing point set C₀ from FIG. 31. The result of the Complement Test is shown in FIG. 33, which comprises the intersection I(C₀, G) of the probing set C₀ and the student's geometry G. Since the set I(C₀, G) shown in FIG. 33 is not empty, the student's solution G fails the Complement Test. Again, the set I(C₀, G) can be passed to the student as a hint where his/her solution is wrong.

### System Architecture

FIG. 34 is a block diagram representing one or more embodiments of the system of the present disclosure and comprising the user's (e.g. student's and instructor's) client computing devices 210 in communication with a testing server 220 (e.g. remote or central server) via a network 230.

The user's client computing device 210 may comprise any type of electronic computing device enabled to communicate via the network 230 with the testing server 220, such as via a web browser. Non-limiting examples of devices 210 comprise: laptop computers, desktop computers, tablet computers, smart phones, etc.

Network 230 is a computer network that relays, at a minimum, data between one or more user's device 210 and the testing server 220. Network 230 may also include the Internet and/or other types of data networks, such as a local area network (LAN), a wide area network (WAN), a cellular network, and a satellite network: (e.g. Ethernet, 802.11, worldwide interoperability for microwave access (WiMAX), 3G, 4G, CDMA, digital subscriber line (DSL), etc.).

The testing server 220 comprises one or more processors and memory to execute CAD software and the testing modules of the present invention. The one or more servers 220 can include one or more sets of computing systems working in parallel to perform various computing tasks, and can be arranged in a single computing rack or distributed amongst various racks in one or more locations. The server(s) 220 may further comprise a database for storing data (e.g. instructor's solutions, probing sets per assignment, student's records-history of grading, etc.).

The CAD software for use with the present invention may reside on the user's device 210, on the testing server 220, or elsewhere, such as a university main frame computer system; and, it may comprise commercially available CAD tutorials. The testing modules of the present invention (e.g. Bounding boxes, Size, Position, Inclusion, and Complement Tests) may also be incorporated into and co-reside with the commercial CAD software on a computer server (e.g. the testing server 220), or the testing modules may reside remotely but remain accessible via the network 230 to the CAD software. A non-limiting example comprises the testing modules residing on or being accessible by the testing server 220 while the CAD software that the student used to compute their solution G resides on another computing system (e.g. student's, university's and/or third party's that may be accessible via the network 230).

### User's Client Computing Device &/or Testing Server

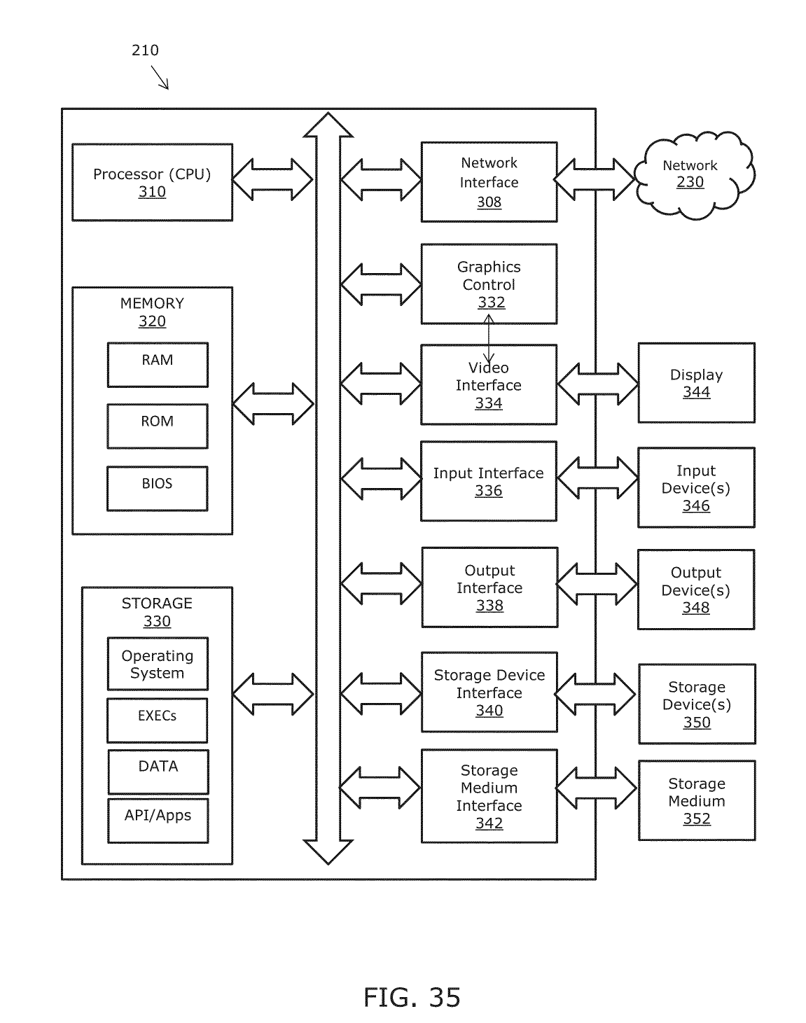

FIG. 35 is a block diagram of one embodiment of the user's (student's and instructor's) electronic computing device 210 and/or testing server 220, which may have CAD software and/or testing modules (e.g. Bounding boxes, Size, Position, Inclusion, and Complement Tests) installed thereon, or accessible via the network. In this present exemplification, device 210 is a laptop or desktop computer, but this is not meant to be limiting representations. Rather it merely illustrates some examples and that others are also envisioned. For example, those skilled in the art can readily recognize, though, that various components, subsystems, features, etc. disclosed herein also apply to the testing server 230. And, that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention.

The user's device 210 comprises a processor (CPU) 310, a memory 320, and a storage 330 that communicate with each other, and with other components, via a bus. Processor(s) 310 (or central processing unit(s) (CPU(s))) optionally contains a cache memory unit for temporary local storage of instructions, data, or computer addresses (e.g. CAD data). They are configured to assist in execution of computer readable instructions. Device 210 may provide functionality as a result of the processor(s) 310 executing software embodied in one or more tangible computer-readable storage media, such as memory 320, storage 330, storage devices 350, and/or storage medium 352. The computer-readable media may store software that implements particular embodiments, and processor(s) 310 may execute the software.

Memory 320 may read the software from one or more other computer-readable media (such as mass storage device(s) 340, 342) or from one or more other sources (e.g. testing server 220) through a suitable interface, such as network interface 230. The software may cause processor(s) 310 to carry out one or more processes or one or more steps of one or more processes described or illustrated herein. Carrying out such processes or steps may include defining data structures stored in memory 320 and modifying the data structures as directed by the software.

The memory 320 further comprises various components (e.g., machine readable media) including, but not limited to, a random access memory component (RAM) (e.g., a static RAM “SRAM”, a dynamic RAM “DRAM, etc.), a read-only component (ROM), and any combinations thereof. ROM may act to communicate data and instructions uni-directionally to processor(s) 310, and RAM may act to communicate data and instructions bi-directionally with processor(s) 310. ROM and RAM may include any suitable tangible computer-readable media described below. In one example, a basic input/output system (BIOS), including basic routines that help to transfer information between elements within device 210, such as during start-up, may be stored in the memory 320.

Storage 330 (i.e. fixed storage) is connected bi-directionally to processor(s) 310, optionally through storage control unit (not shown). It provides additional data storage capacity and may also include any suitable tangible computer-readable media described herein. Storage 330 may be used to store the operating system, EXECs (executables), data 511, APV applications (application programs), and the like. Often, although not always, storage 330 is a secondary storage medium (such as a hard disk) that is slower than primary storage (e.g., memory 320). Storage 330 can also include an optical disk drive, a solid-state memory device (e.g., flash-based systems), or a combination of any of the above. Information in storage 330 may, in appropriate cases, be incorporated as virtual memory in memory 320.

In particular embodiments, when device 210 is connected to network 230, it may communicate with other devices and/or the testing server 220. Communications to and from device 210 may be sent through network interface 308, that receives incoming communications (such as requests or responses from other devices) in the form of one or more packets (such as Internet Protocol (IP) packets) from network 230. Device 210 may store the incoming communications in memory 320 for processing, and/or store outgoing communications (such as requests or responses to other devices) in the form of one or more packets in memory 310 and communicated to network 320 from network interface 308. Processor(s) 501 may access these communication packets stored in memory 310 for processing.

Examples of the network interface 308 include, but are not limited to, a network interface card, a modem, and any combination thereof. Examples of a network 230 or network segment 230 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 230, may employ a wired and/or a wireless mode of communication. In general, any network topology may be used.

Device 210 may also include an input device 346 to enter commands and/or other information. Examples of an input device(s) 346 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 346 may be interfaced to the bus via any of a variety of input interfaces 336 including, but not limited to, serial, parallel, game port, USB, FIREWIRE, THUNDERBOLT, or any combination of the above. In an embodiment, the input interface is configured to receive user activity data from a network (e.g., the Internet or a cellular data network).

Information and data can be displayed through a display 344, examples include, but are not limited to, a liquid crystal display (LCD), an organic liquid crystal display (OLED), a cathode ray tube (CRT), a plasma display, and any combinations thereof. The display 344 can interface to the processor(s) 310, memory 320, and fixed storage 330, as well as other devices, such as input device(s) 346 (user input device(s)), via the bus. The display 344 is linked to the bus via a video interface 334, and transport of data between the display 346 and the bus can be controlled via the graphics control 332.

In addition to a display 344, device 210 may include one or more other peripheral output devices 348 including, but not limited to, an audio speaker, a printer, and any combinations thereof. Such peripheral output devices may be connected to the bus via an output interface 338. Examples of an output interface 338 include, but are not limited to, a serial port, a parallel connection, a USB port, a FIREWIRE port, a THUNDERBOLT port, and any combinations thereof.

In addition or as an alternative, device 210 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

### CONCLUSION

The various embodiments of the present invention may also be in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

Lastly, the various embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computerized method to automatically assess the correctness of a user's solution G to a computer-aided design (CAD) assignment, comprising:
a. computing and storing in a testing server's memory a probing data selected by the instructor or creator of the CAD assignment;
b. receiving a user's solution to the CAD assignment by the testing server;
c. assessing the correctness of the user's solution by a processor(s) of the testing server;
d. displaying by the testing server whether the solution is correct; and,
e. wherein if the user's solution is not correct, then it may be corrected and re-submitted by the user, and re-assessed for correctness by the testing server.

2. The computerized method of claim 1, wherein the user's solution is computed on a user's client computing system and transmitted to the testing server over a network, or it is computed on the testing server utilizing CAD software installed therein and accessible via the network.

3. The computerized method of claim 1, wherein the probing data comprises one or more items of the following list:
a. a bounding box B(S), i.e., the smallest rectangle (in 2D) or brick (in 3D) that contains the instructor's approved solution S as a subset, and whose edges are parallel to the coordinate axes;
b. Subset S₀ of the instructor's solution S; and,
c. Subset C₀ of the complement C(S).

4. The computerized method of claim 3, wherein assessing the correctness of the user's solution G comprises the processor computing the bounding box B(G) of the user's solution G, and then conducting a Size Test to determine whether the dimensions of the bounding box B(G) of the user's solution G matches the dimensions of the bounding box B(S) of the instructor's solution S.

5. The computerized method of claim 4, wherein if the Size Test fails, then the testing server displays a message that the user's solution has different outer dimensions than the instructor's solution.

6. The computerized method of claim 4, wherein if the user's solution G passes the Size Test, and:
a. if the absolute position is required in the assignment, then the testing server processor conducts a Position Test to determine if the bounding boxes of the user's solution B(G) and the instructor's solution B(S) match; or,
b. if the absolute position is not required in the assignment, then the user's solution G is translated by the CAD software so that the bounding boxes of the user's solution B(G) and the instructor's solution B(S) are identical.

7. The computerized method of claim 6, wherein if the Position test fails, then the testing server displays a message that the user's solution has the correct outer dimensions but its absolute position in plane or space is wrong; and, the different positions of the bounding boxes B(G) and B(S).

8. The computerized method of claim 4, wherein the processor conducts an Inclusion Test to determine if the probing point set S₀ is a subset of the user's solution G, comprising the steps of:
a. calculating the intersection I(S₀, G) of the point sets S₀ and G;
b. subtracting I(S₀, G) from S₀ and denoting the result by X(S₀, G); and,
c. if X(S₀, G) is an empty set, then the Inclusion Test is passed, otherwise it failed and the testing server displays a message that the user's solution has different geometry than the instructor's solution S, and an image of the non-empty set X(S₀, G).

9. The computerized method of claim 6, wherein the processor conducts an Inclusion Test to determine if the probing set S₀ is a subset of the user's solution G, comprising the steps of:
a. calculating the intersection I(S₀, G) of the point sets S₀ and G;
b. subtracting I(S₀, G) from S₀ and denoting the result by X(S₀, G); and,
c. if X(S₀, G) is an empty set, then the Inclusion Test is passed, otherwise it otherwise it failed and the testing server displays a message that the user's solution has different geometry than the instructor's solution S, and an image of the non-empty set X(S₀, G).

10. The computerized method of claim 4, further comprising the processor conducting a Complement Test to determine if the user's solution G overlaps with the probing subset C₀ of the complement C(S).

11. The computerized method of claim 6, further comprising the processor conducting a Complement Test to determine if the user's solution G overlaps with the probing subset C₀ of the complement C(S)

12. A non-transitory computer readable medium including instructions, that when executed by a processing unit, cause the processing unit to provide instructional information to an end user of a software application, by performing the steps of:
a. computing and storing in a testing server memory a probing point set comprising,
i. a bounding box comprising the smallest rectangle (in 2D) or brick (in 3D) that contains the instructor's solution as a subset, and whose edges are parallel to the coordinate axes;
ii. Subset S₀ of the instructor's solution S; and,
iii. Subset C₀ of the complement C(S);
b. receiving a user's solution to the CAD assignment by the testing server;
c. assessing the correctness of the user's solution by a processor(s) of the testing server;
d. displaying by the testing server on the user's client computing system accessed via a network whether the solution is correct; and,
e. wherein if the user's solution is not correct, then it may be corrected and re-submitted by the user, and re-assessed for correctness by the testing server.

13. The non-transitory computer readable medium of claim 12 further comprising instructions for the processor to compute the bounding box B(G) of the user's solution G, and then conducting a Size Test to determine whether the dimensions of the bounding box B(G) of the user's solution G matches the dimensions of the bounding box B(S) of the instructor's solution S.

14. The non-transitory computer readable medium of claim 13 further comprising instructions wherein if the user's solution G passes the Size Test, and:
a. if the absolute position is required in the assignment, then the testing server processor conducts a Position Test to determine if the bounding boxes of the user's solution B(G) and the instructor's solution B(S) match; or,
b. if the absolute position is not required in the assignment, then the user's solution G is translated by the CAD software so that the bounding boxes of the user's solution B(G) and the instructor's solution B(S) are identical.

15. The non-transitory computer readable medium of claim 13 further comprising instructions for the processor to conduct an Inclusion Test to determine if the probing set S₀ is a subset of the user's solution G.

16. The non-transitory computer readable medium of claim 13 further comprising instructions for the processor to conduct a Complement Test to determine if the user's solution G overlaps with the probing subset C₀ of the complement C(S).

17. A network-based computing system for automatically assessing the correctness of a solution to a computer-aided design (CAD) assignment submitted over a network, comprising:
a. a system computer comprising a processor and a memory device operably connected to one another, and a plurality of computer-executable instructions stored on said memory device and executed by said processor, comprising:
i. a CAD computer-executable instructions to create 2D and/or 3D geometries;
ii. a CAD assignment assessment computer-executable instructions to evaluate the correctness of the 2D and/or 3D geometries submitted by a student to an instructor's assignment;
iii. a database storing one or more CAD assignments with an instructor's solution, for each instructor solution a complete probing point set comprising:
a bounding box comprising the smallest rectangle (in 2D) or brick (in 3D) that contains the instructor's solution S, and whose edges are parallel to the coordinate axes;
Subset S₀ of the instructor's solution S;
Subset C₀ of the complement C(S);
b. one or more student's and instructor's client computing systems in communication with the system computer over a network to submit a user's solution to a CAD assignment; and,
c. a wired or wireless network connection between the system computer and the one or more client computing systems.

18. The system of claim 17, wherein the CAD assignment assessment computer-executable instructions comprises instructions for the processor to assess compute the bounding box B(G) of the user's solution G, and then conduct a Size Test to determine whether the dimensions of the bounding box B(G) of the user's solution G matches the dimensions of the bounding box B(S) of the instructor's solution S.

19. The system of claim 17, wherein the CAD assignment assessment computer-executable instructions comprises instructions for the processor to conduct a Position Test to determine if the bounding boxes B(G) and B(S) are identical.

20. The system of claim 17, wherein the CAD assignment assessment computer-executable instructions comprises instructions for the processor to conduct an Inclusion Test to determine if the probing set S₀ is a subset of the user's solution G, comprising the steps of:
a. calculating the intersection I(S₀, G) of the point sets S₀ and G;
b. subtracting I(S₀, G) from S₀ and denoting the result by X(S₀, G); and,
c. if X(S₀, G) is an empty set, then the Inclusion Test is passed, otherwise it is failed.

21. The system of claim 17, wherein the CAD assignment assessment computer-executable instructions comprises instructions for the processor to conduct a Complement Test to determine if the user's solution G overlaps with the probing subset C₀ of the complement C(S).
